(19) United States
(12) Patent Application Publication
(10) Pub. No.: US 2016/0285569 A1
(43) Pub. Date: Sep. 29, 2016

(54) RADIO BASE STATION, USER TERMINAL AND RADIO COMMUNICATION METHOD

(71) Applicant: NTT DOCOMO, INC., Tokyo (JP)

(72) Inventors: Satoshi Nagata, Tokyo (JP); Yoshihisa Kishiyama, Tokyo (JP); Xiang Yun, Beijing (CN); Lan Chen, Beijing (CN)

(73) Assignee: NTT DOCOMO, INC., Tokyo (JP)

(21) Appl. No.: 14/778,121

(22) PCT Filed: Feb. 25, 2014
(86) PCT No.: PCT/JP2014/054418

§ 371 Date: Sep. 18, 2015

(30) Foreign Application Priority Data
Apr. 4, 2013 (JP) 2013-078688

(51) Int. Cl. H04B 17/309; H04W 24/08; H04W 72/04; H04L 5/00

(52) U.S. Cl. CPC H04B 17/309; H04L 5/0048; H04W 24/08; H04W 72/0453

(57) ABSTRACT

The present invention is designed to adequately measure the received quality of small cells on the user terminal side. A radio base station communicates with a user terminal by using a plurality of carriers into which a communication band is divided, and has a generating section that generates reference signals for allowing the user terminal to measure received quality, and an allocation section that controls the allocation of the reference signals, and, when one of the plurality of carriers is made subject to non-transmission, the allocation section configures a zero-power RS in a predetermined resource location of a specific carrier.

### TECHNIQUE FIELD

The present invention relates to a radio base station, a user terminal and a radio communication method in a next-generation mobile communication system in which a macro cell and a small cell are placed to overlap each other at least in part.

### BACKGROUND ART

In LTE (Long Term Evolution) and successor systems of LTE (referred to as, for example, “LTE-advanced,” “FRA (Future Radio Access)” and “4G”), a radio communication system (referred to as, for example, “HetNet” (Heterogeneous Network)) to place small cells (including pico cells, femto cells and so on) having a relatively small coverage of a radius of approximately several meters to several tens of meters, in a macro cell having a relatively large coverage of a radius of approximately several hundred meters to several kilometers, is under study (for example, non-patent literature 1).

For this radio communication system, a scenario to use the same frequency band in both the macro cell and the small cells (also referred to as, for example, “co-channel”) and a scenario to use different frequency bands between the macro cell and the small cells (also referred to as, for example, “separate frequencies”) are under study. To be more specific, the latter scenario is under study to use a relatively low frequency band (for example, 2 GHz) in the macro cell, and use a relatively high frequency band (for example, 3.5 GHz or 10 GHz) in the small cells. Also, there is a plan to use a plurality of carriers (for example, component carriers (CCs)) in each small cell.

### CITATION LIST

### Non-Patent Literature

Non-Patent Literature 1: 3GPP TR 36.814, “E-UTRA Further Advancements for E-UTRA Physical Layer Aspects”

### SUMMARY OF INVENTION

### Technical Problem

In a radio communication system in which a plurality of small cells are placed in a macro cell, a user terminal may measure the received quality of small cells that are present nearby, and report the measurement results to a radio base station, and the radio base station may determine the small cell to which the user terminal should connect, based on the measurement results fed back from the user terminal. In this case, how the user terminal should measure the received quality of the small cells is the problem.

The present invention has been made in view of the above, and it is therefore an object of the present invention to provide a radio base station, a user terminal and a radio communication method whereby the received quality of small cells can be adequately measured on the user terminal side.

### Solution to Problem

A radio base station, according to the present invention, is a radio base station to communicate with a user terminal by using a plurality of carriers into which a communication band is divided, which has a generating section that generates reference signals for allowing the user terminal to measure received quality, and an allocation section that controls allocation of the reference signals, and, when one of the plurality of carriers is made subject to non-transmission, the allocation section configures a zero-power RS in a predetermined resource location of a specific carrier.

### Advantageous Effects of Invention

According to the present invention, it is possible to adequately measure the received quality of small cells on the user terminal side.

### BRIEF DESCRIPTION OF DRAWINGS

FIG. 1 is a conceptual diagram of a radio communication system (separate frequencies) using different frequency bands between a macro cell and small cells;

FIG. 2 provides diagrams to explain examples of arrangements of frequency regions used respectively in a macro cell and small cells and measurement methods;

FIG. 3 is a diagram to illustrate an example of a resource grid provided for each cell and each CC;

FIG. 4 provides diagrams to illustrate examples of the status of small cells;

FIG. 5 provides diagrams to explain an RSSI measurement method according to a first example;

FIG. 6 provides diagrams to explain an RSSI measurement method according to a first example;

FIG. 7 is a diagram to explain a conventional CSI measurement method;

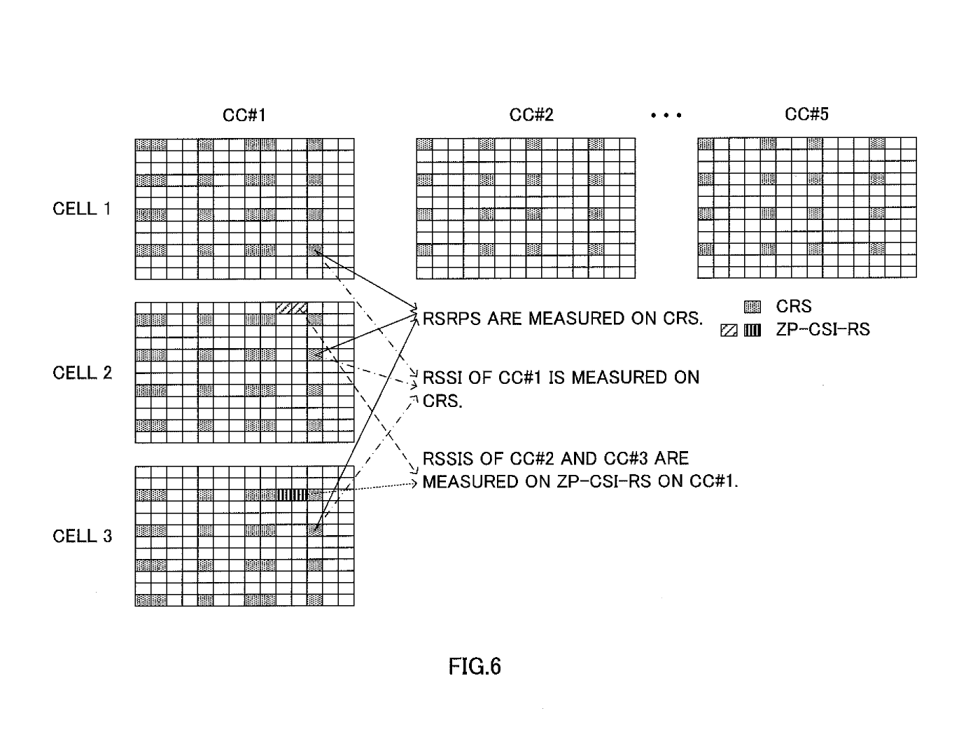

FIG. 6 is a diagram to explain a CSI measurement method according to a first example;

FIG. 9 is a diagram to explain an RSSI measurement method according to a second example;

FIG. 10 is a schematic diagram to illustrate an example of a radio communication system according to the present embodiment;

FIG. 11 is a block diagram to illustrate a structure of a radio base station according to the present embodiment;

FIG. 12 is a block diagram to illustrate a structure of a macro base station according to the present embodiment;

FIG. 13 is a block diagram to illustrate a structure of a small base station according to the present embodiment; and

FIG. 14 is a block diagram to illustrate a structure of a user terminal according to the present embodiment.

### DESCRIPTION OF EMBODIMENTS

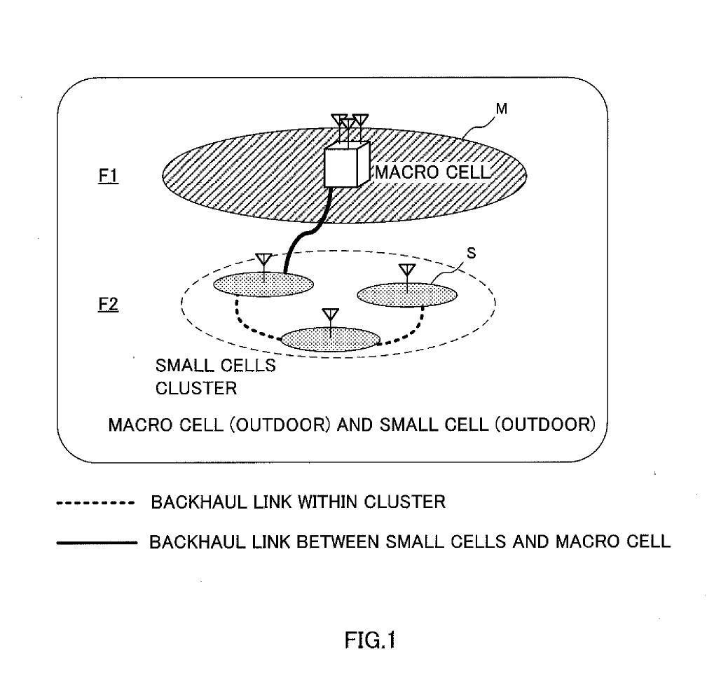

FIG. 1 is a conceptual diagram of a radio communication system (separate frequencies) using different frequency bands between a macro cell and small cells. In the radio communication system illustrated in FIG. 1, a macro cell M to use F1 of a relatively low frequency (carrier) such as, for example, 2 GHz and 800 MHz, and small cells S to use F2 of a relatively high frequency (carrier) such as 3.5 GHz are placed to overlap each other geographically.

The radio communication system illustrated in FIG. 1 is formed by including a radio base station that forms the macro cell M (hereinafter referred to as the “macro base station”) and radio base stations that form the small cells S (hereinafter referred to as the “small base stations”), and a user terminal that communicates with the macro base station and the small base stations.

Also, as illustrated in FIG. 1, the macro base station (macro cell M) and the small base stations (small cells S) may be connected via a channel (non-ideal backhaul) of relatively low speed (medium delay) such as the X2 interface, or may be connected via a channel (ideal backhaul) of relatively high speed (low delay) such as optical fiber.

The small base stations (small cells S) may be connected via a channel (non-ideal backhaul) of relatively low speed (medium delay) such as the X2 interface, or may be connected via a channel (ideal backhaul) of relatively high-speed (low delay) such as optical fiber. Note that, when the macro base station and the small base stations are connected via optical fiber, the small base stations may be remote radio head stations (RRH stations) that connect with the macro base station.

From the perspective of sharing information between base stations, it is preferable to connect between the base stations via the ideal backhaul. On the other hand, when many small base stations are provided, it may be possible to connect between the small base stations via the non-ideal backhaul from the perspective of cost. In this case, semi-static control is implemented between the small base stations (for example, interference control between the small base stations).

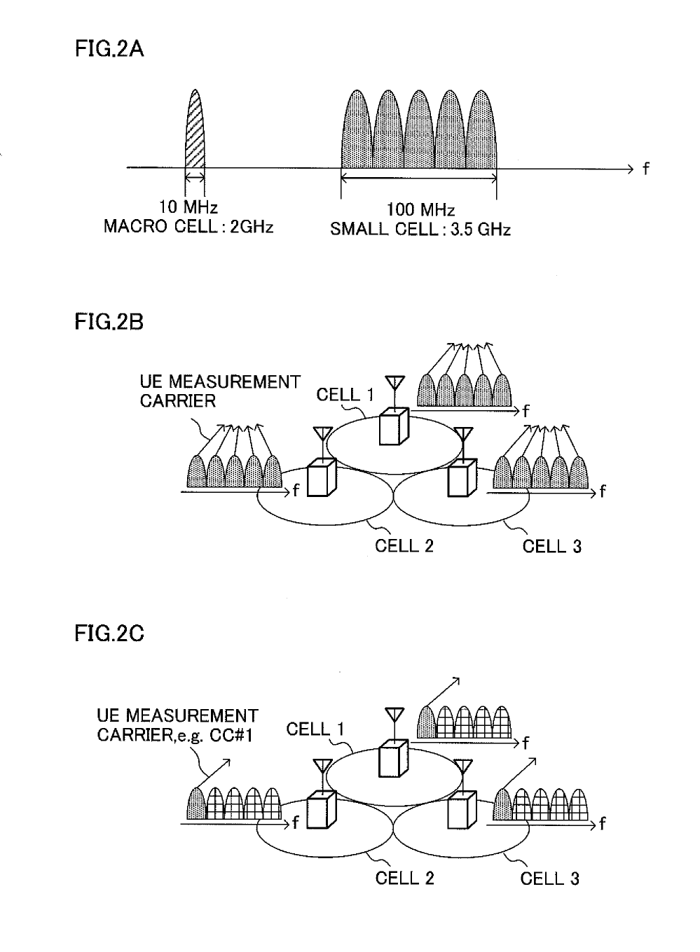

FIG. 2A is a diagram to explain an example arrangement of frequency regions used respectively by the macro cell and the small cells. As illustrated in FIG. 2A, each small cell S can communicate by using a plurality of carriers (or resource blocks (RBs)). In FIG. 2A, broadbandization is achieved by grouping a plurality of (five in FIG. 2A) component carriers (CCs) each having a 20-MHz bandwidth. That is, each small cell S has a 100-MHz (20 MHz×5) bandwidth comprised of CC #1 to CC #5.

FIG. 2B is a diagram to explain a conventional measurement method. When the small cells use five carriers (CC #1 to CC #5), a user terminal is measures the received quality of all of the five CCs of small cell 1, and report the results to a base station (for example, the macro base station). The user terminal carries out the same measurements with respect to small cell 2 and small cell 3 as well. That is, the user terminal needs to measure the received power of every carrier from every nearby small cell, and send reports.

To be more specific, the user terminal measures the RSRP (Reference Signal Received Power) and the RSSI (Received Signal Strength Indicator) based on CRSs (Cell-specific Reference Signals) received from each small cell. Then, the user terminal reports the RSRP and RSRQ (Reference Signal Received Quality) to the base station.

The RSRP means the received signal power of a given specific cell, and can be represented by following equation 1:

For the i-th cell, RSRPᵢ=Sᵢ (Equation 1)

The RSSI means the total received signal power of all cells, and can be represented by following equation 2:

RSSI=N Σₗ₌₁^{L} S₁ (Equation 2)

Here, N is the number of resource blocks (RBs) in the RSSI measurement band.

The RSRQ means the ratio of the RSRP and the RSSI, and can be represented by following equation 3:

$${RSRQ}_{i} = N \times \frac{{RSRP}_{i}}{RSSI} = {S}_{i} / ( {\sum }_{l = 1}^{L} l ) \qquad ( Equation 3 )$$

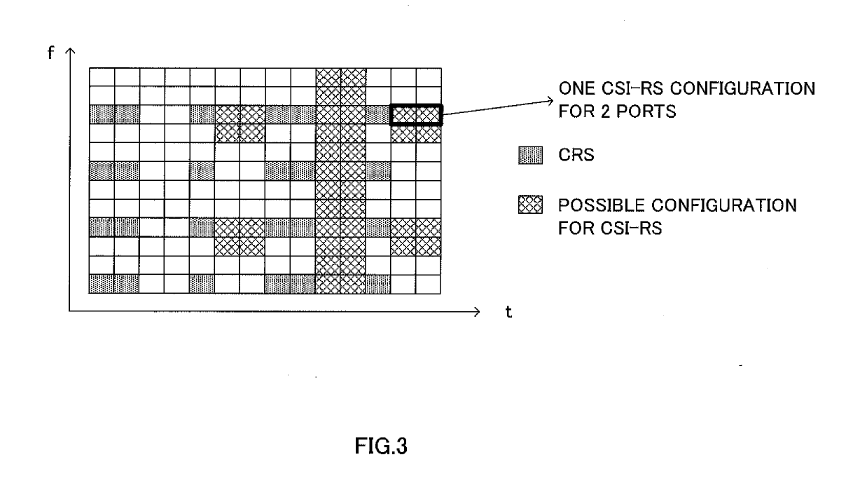

FIG. 3 illustrates an example of a resource grid (frequency-time) provided for each cell and each CC. The CRSs are cell-specific reference signals, and the RSRP and the RSRQ are measured based on the CRSs. The CSI-RSs (Channel State Information Reference Signals) are reference signals to be used to measure CSI such as CQIs (Channel Quality Indicators), PMIs (Precoding Matrix Indicators) and RIs (Rank Indicators) as channel states. The CSI-RSs use two consecutive symbols that do not collide with the CRSs, and are multiplexed over time-frequency resources.

Note that zero-power CSI-RSs (ZP-CSI-RSs) and non-zero-power CSI-RSs (NZP-CSI-RSs) are defined as CSI-RSs. With the ZP-CSI-RSs, the transmission power is not distributed to the resources where the CSI-RSs are allocated, and the CSI-RSs are muted. On the other hand, with the NZP-CSI-RSs, the transmission power is distributed over the resources where the CSI-RSs are allocated.

In this way, when small cells use a plurality of carriers, according to conventional measurement methods, a user terminal needs to measure the received power of reference signals (CRSs) on a per CC basis, and send feedback to a base station. Consequently, if the small cells use a large number of CCs, there is a threat that the process in the measurement becomes complex.

In view of this, the present inventors have conceived of a measurement method that is more simplified, as illustrated in FIG. 2C. To be more specific, even when small cells use a plurality of carriers, a user terminal carries out measurements using one given CC (for example, CC #1).

That is to say, the user terminal carries out measurements based on the assumption that the received quality of the other carriers (the rest of CC #2 to CC #5) is the same as the received quality of CC #1. This method offers an advantage of reducing the complexity of processes in the user terminal upon measurements even when the small cells use a plurality of carriers. Furthermore, there is also an advantage that the overhead of reference signals for measurements can be reduced.

Now, when interference control (ICIC: Inter-Cell Interference Coordination) is carried out semi-statically between small cells, there is a method to control transmission/non-transmission of carriers (CCs) between the small cells. For example, in an interring cell that interferes with nearby cells, a specific CC is made subject to non-transmission (placed in muting status). With this interference control method, muting status is controlled per CC of nearby cells, so that every CC has a possibility of representing a different RSSI due to the muting (non-transmission) status that varies between the cells.

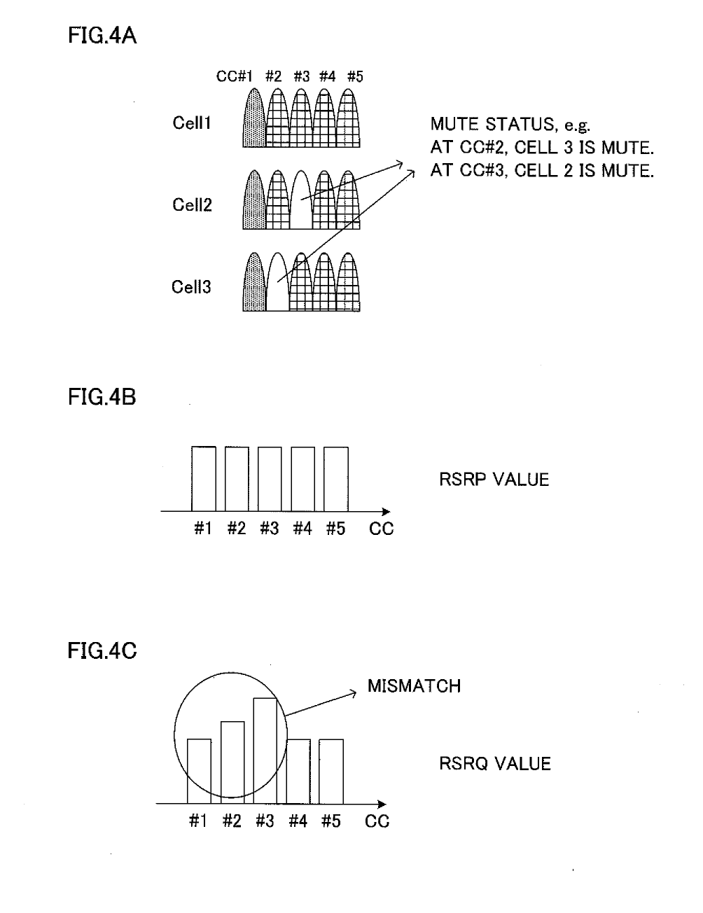

For example, in the example illustrated in FIG. 4A, small cell 3 is made subject to non-transmission in CC #2, and small cell 2 is made subject to non-transmission in CC #3. In this case, in small cell 1, signals are transmitted in CC #1 to CC #5, so that the RSRPs of small cell 1 in CC #1 to CC #5 are all on an equal level, as illustrated in FIG. 4B. Meanwhile, the RSSIs in CC #1 to CC #5 can be respectively represented as follows:

RSSI on CC #1=N(S₁+S₂+S₃)

RSSI on CC #2=N(S₁+S₂)

RSSI on CC #3=N(S₁+S₃)

RSSI on CC #4=N(S₁+S₂+S₃)

RSSI on CC #5=N(S₁+S₂+S₃)

Consequently, as illustrated in FIG. 4C, the RSRQs (=RSRP/RSSI) of small cell 1 in CC #1 (or CC #4 or CC #5), CC #2 and CC #3 do not match. That is, there is a problem that the RSRQ in CC #1 cannot express the RSRQs in other CCs that assume muting status differently among a plurality of cells. Consequently, in above FIG. 2C, if measurements are carried out based on the assumption that the received quality of CC #1 and the received quality of the rest of CC #2 to CC #5 are always the same, there is a threat that the accuracy of measurements decreases.

The present inventors have focused on this point, and made the present invention upon finding out a method whereby, when a user terminal carries out measurements using one given CC (for example, CC #1) in a communication system in which small cells use a plurality of CCs, the user terminal can measure a plurality of RSSIs in CC #1.

To be more specific, for a specific CC (for example, CC #1), reference signals for measuring each cell's received signal power (RSRP), and zero-power RSs (ZP-RSs) for measuring, when one CC is made subject to non-transmission in each cell, the total received signal power of the CC are configured. Alternatively, when one CC is made subject to non-transmission in every cell, an updating rule for acquiring the total received signal power of the CC is reported to the user terminal.

Now, an embodiment of the present invention will be described below in detail with reference to the accompanying drawings. Note that, with the present embodiment, a “base station” refers to either a macro base station or a small base station unless specified otherwise.

### FIRST EXAMPLE

A case will be described with a first example where a plurality of

RSSIs are measured based on a plurality of ZP-RSs that are configured in CC #1 on a per cell basis. Note that, with the first example, ZP-CSI-RSs or NZP-CSI-RSs can be used as ZP-RSs.

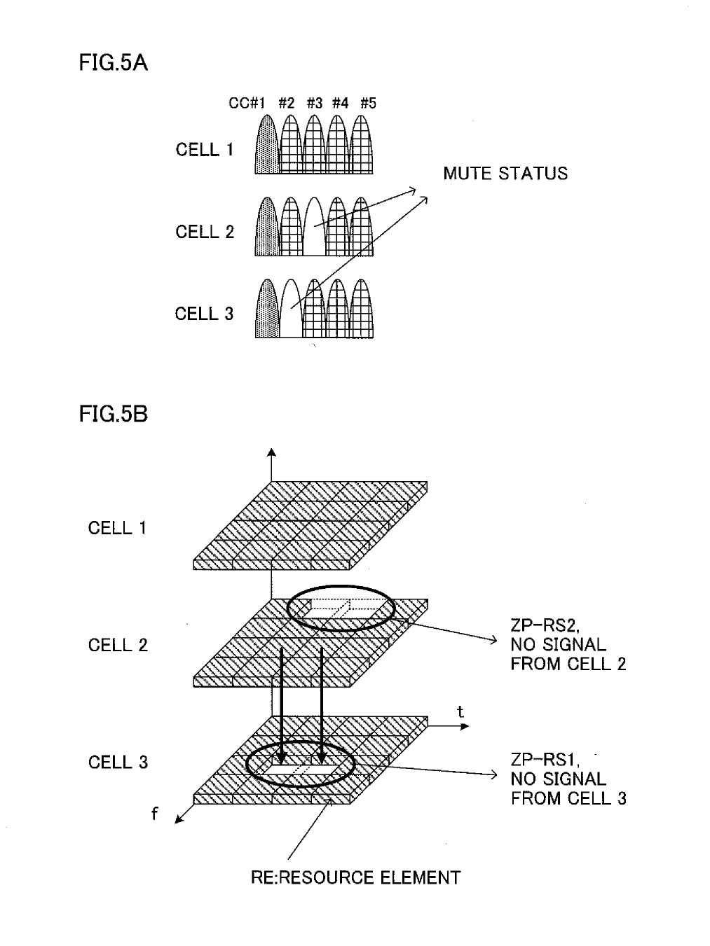

An example case will be described with the first example where, as illustrated in FIG. 5A, every small cell is formed with CC #1 to CC #5, and where small cell 3 is made subject to non-transmission in CC #2, and small cell 2 is made subject to non-transmission in CC #3. Note that the first example is equally applicable when the power is lower than in other CCs, instead of when non-transmission is assumed. In this case, NZP-CSI-RSs can be used as ZP-RSs.

As illustrated in FIG. 5B, the base station configures a plurality of ZP-RSs in CC #1, in order to simulate the conditions of received quality in CC #2 to CC #5 in CC #1 in a virtual manner. That is to say, small cells that place one of CC #2 to CC #5 in muting status (non-transmission) configure ZP-RSs in CC #1. Also, the base station reports the measurement region such as those illustrated in FIG. 5B to the user terminal.

For example, in small cell 3, CC #2 is made subject to non-transmission. Consequently, the base station of small cell 3 configures ZP-RS1 in CC #1 to synchronize with the time when CC #2 assumes non-transmission. By this means, in the resource region where ZP-RS1 for CC #1 is configured, it is possible to simulate CC #2.

Also, in small cell 2, CC #3 is made subject to non-transmission. Consequently, the base station of small cell 2 configures ZP-RS2 in CC #1 to synchronize with the time when CC #3 assumes non-transmission. By this means, in the resource region where ZP-RS2 for CC #1 is configured, it is possible to simulate CC #3.

Note that, in the case of FIG. 5, every cell places a different CC in muting status, so that ZP-RS1 and ZP-RS2 are configured in different resource locations. Also, the resource locations of the ZP-RSs that are configured in CC #1 to simulate the rest of CC #2 to CC #5 may be defined in advance, or may be reported to the user terminal. For example, it is possible to use CSI-RS configurations that are already defined.

A user terminal measures RSSIs from a plurality of ZP-RSs configured. Note that the RSSIs to be measured from the resource simulating CC #2 by configuring ZP-RS1 in small cell 3 and the resource simulating CC #3 by configuring ZP-RS2 in small cell 2 can be respectively represented as follows:

RSSI on ZP-RS1=N(S₁+S₂)

RSSI on ZP-RS2=N(S₁+S₃)

FIG. 6 is a diagram to illustrate the resource grids of small cell 1 to small cell 3 in each CC, illustrated in FIG. 5A. The user terminal measures the RSRP/RSSI of each small cell (small cell 1 to small cell 3) in CC #1. In this case, given that CC #1 simulates the conditions of received quality in the rest of CC #2 to CC #5 in a virtual manner, the user terminal measures the RSSIs of a plurality of CCs in CC #1.

The user terminal measures the RSRP of each small cell in CC #1 based on CRSs. Also, the user terminal measures the RSSIs in CC #1 based on CRSs.

Furthermore, the user terminal measures the RSSI in CC #3, where small cell 2 is made subject to non-transmission, based on the ZP-CSI-RS (ZP-RS2) that is configured in CC #1. Furthermore, the user terminal measures the RSSI in CC #2, where small cell 3 is made subject to non-transmission, based on the ZP-CSI-RS (ZP-RS1) that is configured in CC #1.

In this way, by simulating the conditions of received quality in CC #2 to CC #5 in CC #1 in a virtual manner, it is possible to concentrate the reference signals in the resource grids of CC #1, and reduce the overhead (the density of placing reference signals) in the rest of CC #2 to CC #5.

As described above, according to the first example, it is possible to newly define a plurality of RSSIs with one CC based on a plurality of ZP-RSs. This is advantageous when a plurality of cells independently carry out semi-static control such as non-transmission control in each CC.

Also, the above method is applicable even when the user terminal generates channel state information (CSI) based on CSI-RSs.

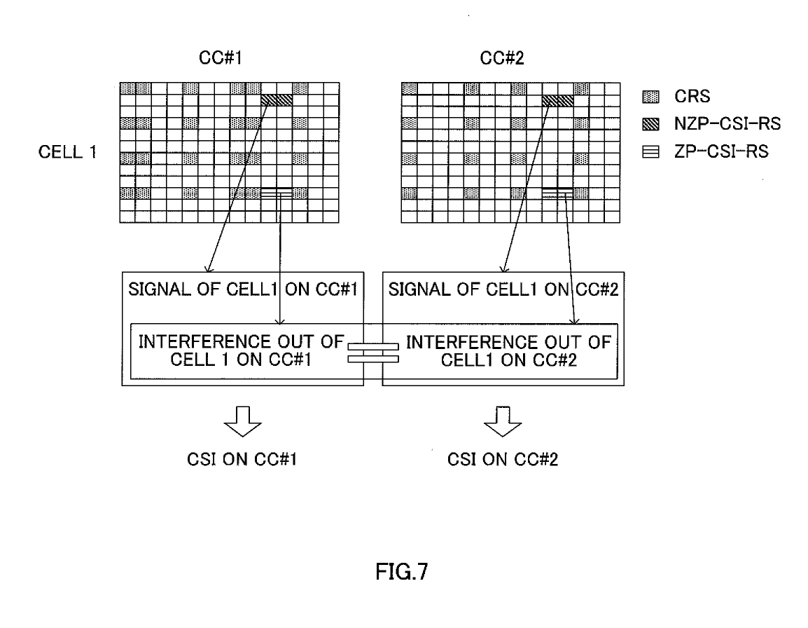

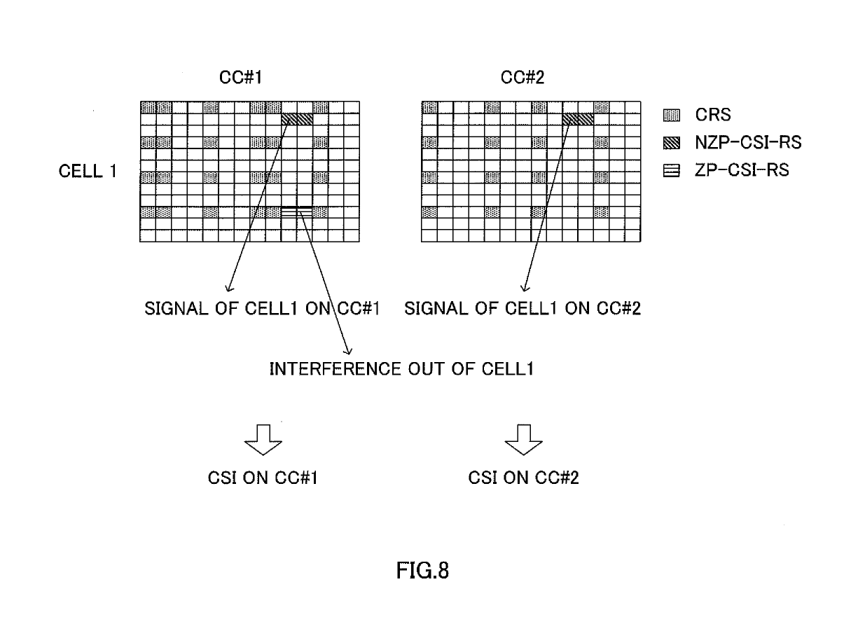

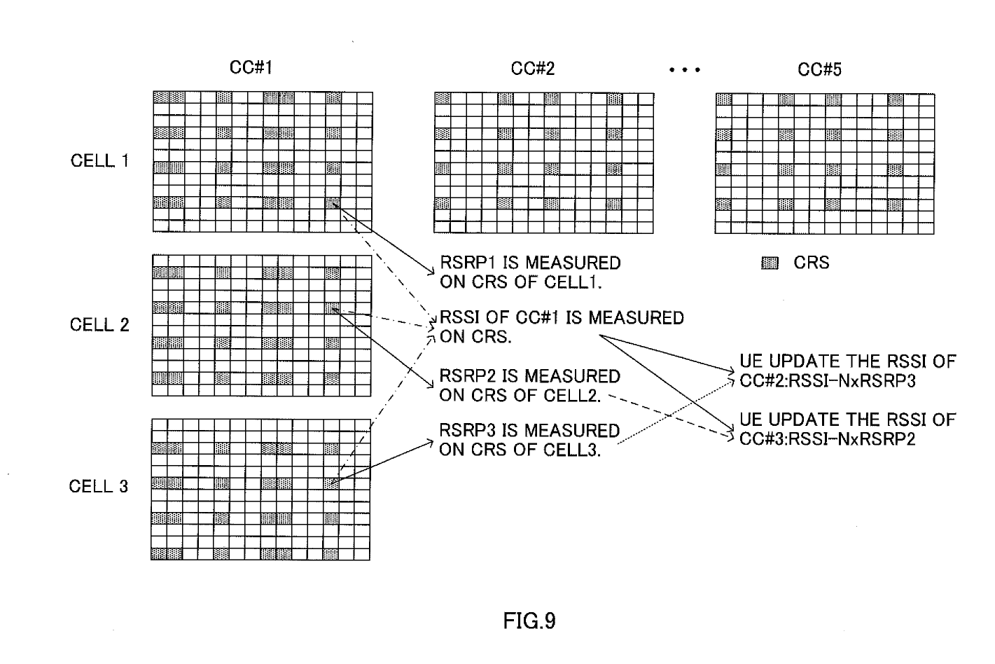

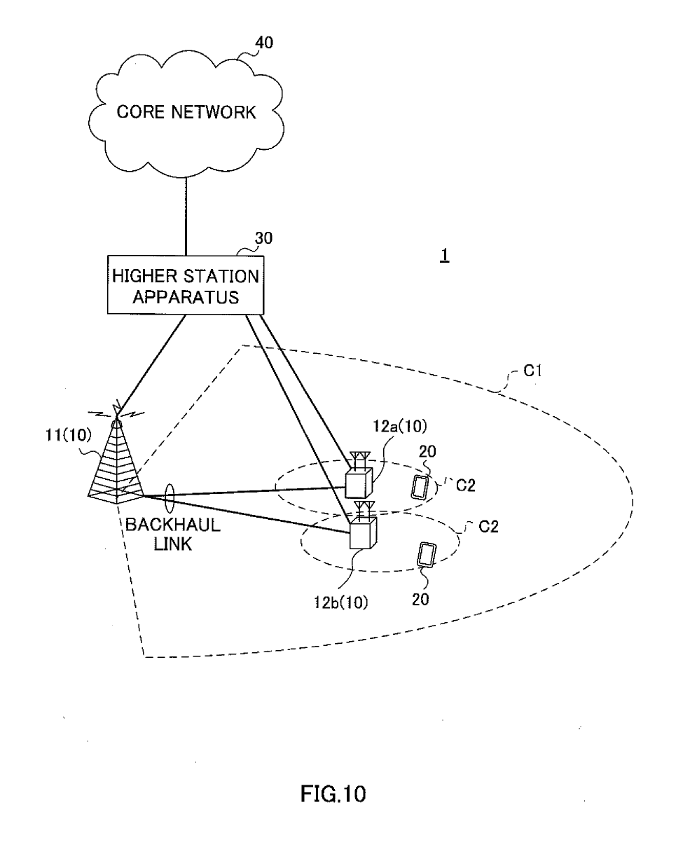

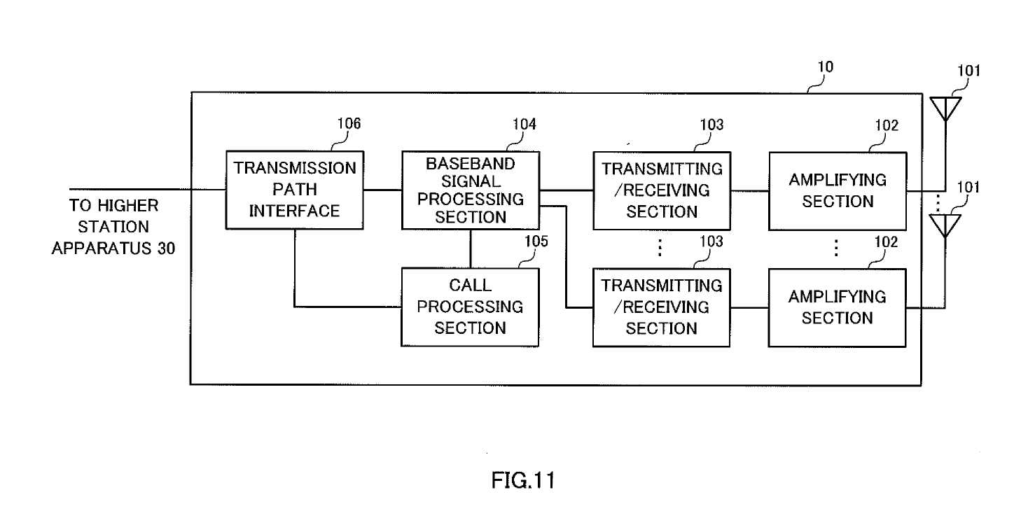

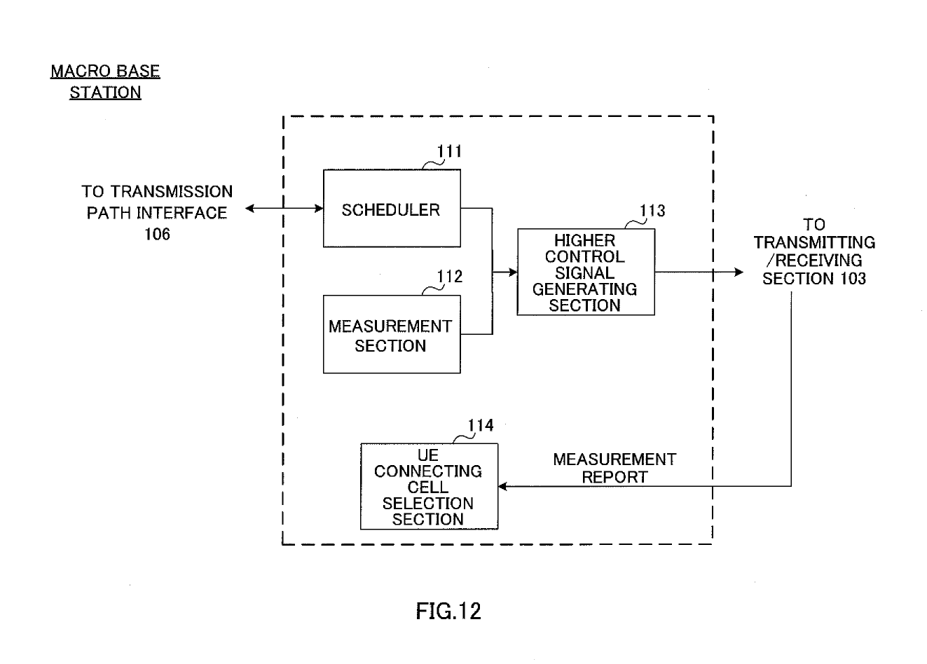

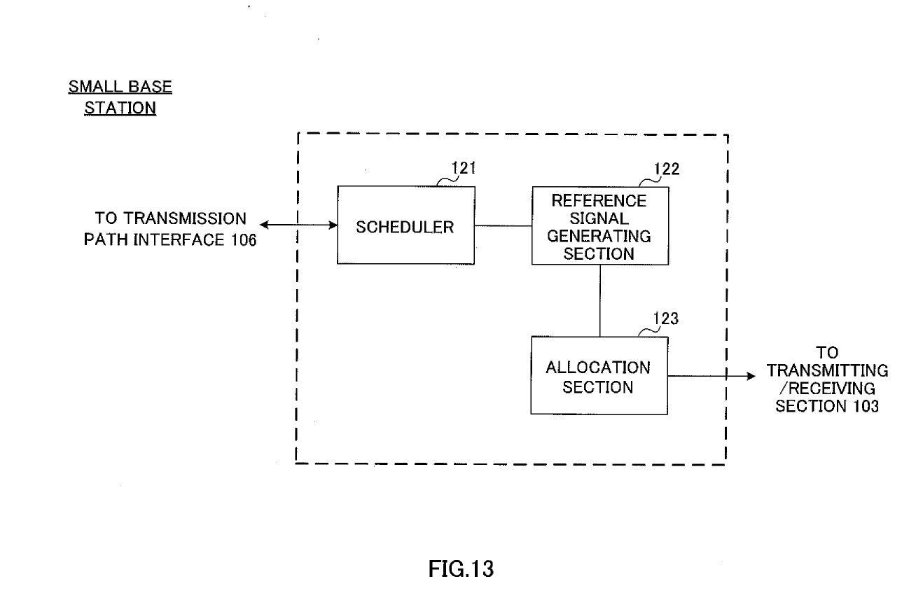

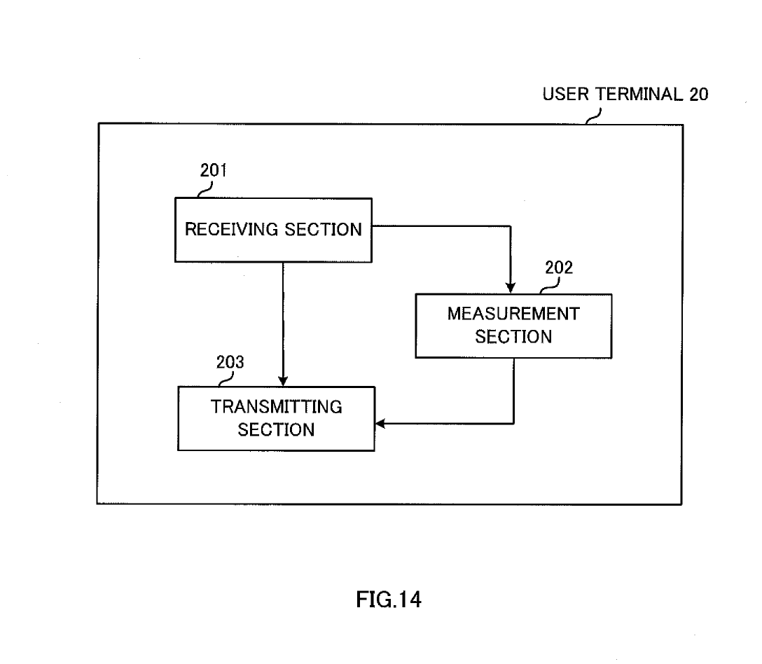

When channel states are calculated using CSI-RSs, it is important to take into account the impact of interference from other transmission points (other small cells). With conventional CSI measurement methods, for example, as illustrated in FIG. 7, in CC #1 for small cell 1, the CSI in CC #1 is calculated by using a NZP-CSI-RS to estimate desired signal power and a ZP-CSI-RS to estimate interference signal power. Similarly, in CC #2 of small cell 1, too, the CSI in CC #2 is calculated by using a NPZ-CSI-RS to estimate desired signal power and a ZP-CSI-RS to estimate interference signal power.

Here, the ZP-CSI-RS for interference signal estimation has a problem of consuming resources wastefully because the same resource for interference signal estimation is configured in a plurality of CCs.

So, the reference signal for interference signal estimation is configured selectively in a resource of a specific CC. For example, as illustrated in FIG. 8, a ZP-CSI-RS is configured selectively in CC #1 of small cell 1. In this case, the user terminal calculates the desired signal intensity in each CC, based on the NZP-CSI-RS of small cell 1 in each CC (CC #1 and CC #2 illustrated in FIG. 8). Furthermore, based on the ZP-CSI-RS of small cell 1 placed in CC #1, interference from outside small cell 1 is calculated. Then, the CSI measurement method is enhanced so that CSI in each CC is calculated based on these.

By this means, the user terminal is able to calculate the CSI of each small cell in each CC from one desired signal estimation resource that is placed in each CC and one interference signal estimation resource that is placed in CC #1. As a result of this, even when every small cell uses a plurality of CCs, it is still possible to make effective use of radio resources.

### SECOND EXAMPLE

A case will be described with a second example where a user terminal updates a plurality of RSSIs in accordance with higher layer signaling from a base station such as, for example, RRC (Radio Resource Control) signaling or broadcast signals.

To be more specific, the base station configures and reports the updating rule for determining the RSSI in each CC to the user terminal. For example, the base station configures an updating rule including a cell index and a calculation command (a command as to whether to use addition or subtraction). The updating rule is coordinated with the muting pattern that changes semi-statically in other cells. The user terminal updates a plurality of RSSIs following this updating rule.

An example case will be described with the second example where, similar to the first example, as illustrated in FIG. 5A, every small cell is formed with CC #1 to CC #5, and where small cell 3 is made subject to non-transmission in CC #2, and small cell 2 is made subject to non-transmission in CC #3.

The base station (for example, the macro base station) judges, as a result of checking each small cell's muting pattern, that small cell 3 is in muting status (non-transmission) in CC #2. In this case, the base station represents the RSSI of CC #2 as follows. Here, S3 is equivalent to the received power (RSRP) of small cell 3 in CC #1.

RSSI on CC #2=RSSI on CC #1−NxS3

So, the base station commands the user terminal to “subtract” the signal power of small cell 3. The user terminal, receiving the command, uses the RSSI of CC #1 and the RSRP of small cell 3, which are measured in advance, updates the RSSI in CC #2 by subtracting the RSRP of small cell 3 from the RSSI of CC #1, as expressed below, and sends feedback to the base station.

RSSI on CC #2=measured RSSI on CC #1−Nx measured RSRP on cell 3

Similarly, the base station (for example, the macro base station) judges, as a result of checking each small cell's muting pattern, that small cell 2 is in muting status (non-transmission) in CC #3. So, the base station commands the user terminal to “subtract” the signal power of small cell 2. The user terminal, receiving the command, uses the RSSI of CC #1 and the RSRP of small cell 2, which are measured in advance, updates the RSSI in CC #3 by subtracting the RSRP of small cell 2 from the RSSI of CC #1, as expressed below, and sends feedback to the base station.

RSSI on CC #3=measured RSSI on CC #1−Nx measured RSRP on cell 2

In order to improve the accuracy of RSRP measurements, it is possible to carry out measurements by using RSRP1 or a plurality of reference signal such as, for example, CRSs, CSI-RSs and detection signals (discovery signals or discovery reference signals).

FIG. 9 is a diagram to illustrate the resource grids of small cell 1 to small cell 3 in each CC, illustrated in FIG. 5A. The user terminal measures RSRP1 based on the CRS of small cell 1. Similarly, the user terminal measures RSRP2 based on the CRS of small cell 2, and also measures RSRP3 based on the CRS of small cell 3. Also, the user terminal measures the RSSI of CC #1 based on the CRS of CC #1.

After that, the user terminal updates the RSSI based on the updating rule commanded from the base station. To be more specific, the user terminal updates the RSSI of CC #2 by subtracting RSRP3 from the RSSI of CC #1. To be more specific, the user terminal updates the RSSI of CC #3 by subtracting RSRP2 from the RSSI of CC #1.

In this way, the base station commands the updating rule to the user terminal, and the user terminal calculates and updates RSSIs in accordance with RSRPs/RSSIs that are measured and the updating rule, so that it becomes possible to adequately measure a plurality of RSSIs in accordance with each cell's transmission status (transmission/non-transmission) in each CC.

As has been described above, according to the second example, it is possible to define a plurality of RSSIs with one CC in accordance with updating information that is configured by a base station. This is effective in semi-static CC-level control such as non-transmission and power control.

(Structure of Radio Communication System)

Now, a radio communication system according to the present embodiment will be described below in detail. In this radio communication system, the above-described measurement methods according to the first and second examples are employed.

FIG. 10 is a diagram to illustrate a schematic structure of the radio communication system according to the present embodiment. As illustrated in FIG. 10, the radio communication system 1 has a macro base station 11 that forms a macro cell C1 as a first cell, and small base stations 12 (12a and 12b) that form small cells C2 as second cells that are placed in the macro cell C1 and that are narrower than the macro cell C1. Also, in the macro cell C1 and in each small cell C2, user terminals 20 are placed. Note that the numbers of macro cells C1 (macro base stations 11), small cells C2 (small base stations 12) and user terminals 20 are not limited to those illustrated in FIG. 10.

Also, in the macro cell C1 and in each small cell C2, user terminals 20 are placed. The user terminals 20 are configured to be able to perform radio communication with both the macro base station 11 and/or the small base stations 12. Also, the user terminals 20 can communicate with a plurality of small base stations 12 by aggregating the component carriers used in each small cell C2 (carrier aggregation). Alternatively, the user terminals 20 can communicate with the macro base station 11 and the small base stations 12 by aggregating the component carriers used respectively in the macro cell C1 and the small cells C2.

Between the user terminals 20 and the macro base station 11, communication is carried out using a carrier of a relatively low frequency band (for example, 2 GHz). On the other hand, between the user terminals 20 and the small base station 12, a carrier of a relatively high frequency band (for example, 3.5 GHz) is used, but this is by no means limiting. The same frequency band may be used between the macro base station 11 and the small base stations 12.

Also, the macro base station 11 and each small base station 12 may be connected via a channel of relatively low-speed (medium delay) such as the X2 interface (non-ideal backhaul), may be connected via a channel of relatively high-speed (low delay) such as optical fiber (ideal backhaul), or may be connected via radio. Also, the small base stations (small cells S) may be connected via a channel of relatively low-speed (medium delay) such as the X2 interface (non-ideal backhaul), may be connected via a channel of relatively high-speed (low delay) such as optical fiber (ideal backhaul), or may be connected via radio.

The macro base station 11 and the small base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these.

Note that the macro base station 11 is a radio base station having a relatively wide coverage, and may be referred to as an “eNodeB (eNB),” a “radio base station,” a “transmission point” and so on. The small base stations 12 are radio base stations that have local coverages, and may be referred to as “RRHs (Remote Radio Heads),” “pica base stations,” “femto base stations,” “Home eNodeBs,” “transmission points,” “eNodeBs (eNBs)” and so on. The user terminals 20 are terminals to support various communication schemes such as LTE and LTE-A, and may not only be mobile communication terminals, but may also be fixed communication terminals as well.

Also, in the radio communication system 1, a downlink shared channel (PDSCH: Physical Downlink Shared Channel), which is used by each user terminal 20 on a shared basis, downlink control channels (a PDCCH (Physical Downlink Control Channel), an EPDCCH (Enhanced Physical Downlink Control Channel), a PCFICH, a PHICH, a broadcast channel (PBCH) and so on) and so on are used as downlink communication channels. User data and higher control information are transmitted by the PDSCH. Downlink control information (DCI) is transmitted by the PDCCH and the EPDCCH.

Also, in the radio communication system 1, an uplink shared channel (PUSCH: Physical Uplink Shared Channel), which is used by each user terminal 20 on a shared basis, and an uplink control channel (PUCCH: Physical Uplink Control Channel) are used as uplink communication channels. User data and higher control information are transmitted by the PUSCH. Also, downlink radio quality information (CQI: Channel Quality Indicator), delivery acknowledgment information (ACKs/NACKs) and so on are transmitted by the PUCCH.

Now, the structures of the user terminals 20, the macro base station 11 and the small base station 12 will be described with reference to FIG. 11 to FIG. 14. Note that the user terminals 20, the macro base station 11 and the small base stations 12 each have hardware, which includes a communication interface, a processor, a memory, a transmission/reception circuit and so on, and software modules to be executed by the processor are memorized in the memory. The structures illustrated in FIG. 11 to FIG. 14 may be implemented by the above hardware, may be implemented by the software modules that are executed by the processors, or may be implemented by combinations of both.

FIG. 11 is a diagram to illustrate an overall structure of a radio base station 10 (which may be either a radio base station 11 or 12) according to the present embodiment. The radio base station 10 has a plurality of transmitting/receiving antennas 101 for MIMO transmission, amplifying sections 102, transmitting/receiving sections 103, a baseband signal processing section 104, a call processing section 105 and a transmission path interface 106.

User data to be transmitted from the radio base station 10 to a user terminal 20 on the downlink is input from the higher station apparatus 30, into the baseband signal processing section 104, via the transmission path interface 106.

In the baseband signal processing section 104, a PDCP layer process, division and coupling of the user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a pre-coding process are performed, and the result is transferred to each transmitting/receiving section 103. Furthermore, downlink control channel signals are also subjected to transmission processes such as channel coding and an inverse fast Fourier transform, and are transferred to each transmitting/receiving section 103.

Also, the baseband signal processing section 104 reports, to the user terminal 20, control information for allowing communication in the cell, through a broadcast channel. The information for allowing communication in the cell includes, for example, the uplink or downlink system bandwidth and so on. Also, the above-described information related to TPC may be reported to the user terminal by using a broadcast channel. Note that, when the user terminal is connected with both a radio base station 11 and a radio base station 12 (dual connection), it is possible to report the information from the radio base station 12, which functions as a central control station, to the user terminal, by using a broadcast channel.

Each transmitting/receiving section 103 converts the baseband signals, which are pre-coded and output from the baseband signal processing section 104 on a per antenna basis, into a radio frequency band. The amplifying sections 102 amplify the radio frequency signals having been subjected to frequency conversion, and transmit the results through the transmitting/receiving antennas 101.

On the other hand, as for data that is transmitted from the user terminal 20 to the radio base station 10 on the uplink, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, the user data that is included in the input baseband signals is subjected to an FFT process, an IDFT process, error correction decoding, a MAC retransmission control receiving process and RLC layer and PDCP layer receiving processes, and the result is transferred to the higher station apparatus 30 via the transmission path interface 106. The call processing section 105 performs call processing such as setting up and releasing communication channels, manages the state of the radio base station 10 and manages the radio resources.

FIG. 12 is a principle functional structure diagram of a baseband signal processing section 104 provided in a macro base station (radio base station 11) according to the present embodiment. As illustrated in FIG. 12, the baseband signal processing section 104 provided in the radio base station 11 is configured by including a scheduler 111, a measurement section 112, a higher control signal generating section 113, and a UE connecting cell selection section 114.

The scheduler 111 schedules the downlink user data to be transmitted in the PDSCH, the downlink control information to be transmitted in the PDCCH and/or the enhanced PDCCH (EPDCCH), and the reference signals. To be more specific, the scheduler 111 allocates radio resources based on command information from the higher station apparatus 30, feedback information (for example, CSI including CQIs, RIs and so on) from each user terminal 20, and so on. Note that a structure may be employed in which the scheduler 111 schedules every small base station 12.

The measurement section 112 measures the radio quality of each small cell C2. By means of this measurement, the macro base station 11 checks transmission/non-transmission (muting pattern) of each small cell C2 per CC.

When the above first example is employed, the higher control signal generating section 113 generates a higher control signal for allowing the base station to configure a plurality of ZP-RSs in CC #1 in order to simulate the conditions of received quality in CC #2 to CC #5 in CC #1 in a virtual manner. Also, when the above second example is employed, the higher control signal generating section 113 generates a higher control signal for configuring and reporting the updating rule for determining the RSSI in each CC.

The UE connecting cell selection section 114 determines the small base stations 12 to which the user terminals 20 should connect, based on the measurement results fed back from the user terminals 20.

FIG. 13 is a principle functional structure diagram of a baseband signal processing section 104 provided in a macro base station (radio base station 12) according to the present embodiment. As illustrated in FIG. 13, the baseband signal processing section 104 provided in the radio base station 12 is formed by including a scheduler 121, a reference signal generating section 122 and an allocation section 123. Note that, when the small base station 12 operates as a control station—that is, when the small base station 12 receives measurement reports from the user terminals 20 —the small base stations 12 may have the UE connecting cell selection section 114 that is provided in the macro base station 11.

The scheduler 121 schedules the downlink user data to be transmitted in the PDSCH, the downlink control information to be transmitted in the PDCCH and/or the enhanced PDCCH (EPDCCH), and the reference signals. To be more specific, the scheduler 121 allocates radio resources based on command information from the higher station apparatus 30, feedback information (for example, CSI including CQIs, RIs and so on) from each user terminal 20, and so on. Note that when the scheduler 111 in the macro base station 11 schedules each small base station 12, it is also possible to use a structure without a scheduler 121.

The reference signal generating section 122 generates reference signals for allowing the user terminal 20 to measure received quality. For example, the reference signal generating section 122 generates the cell-specific reference signal (CRS) for received power measurement, the zero-power CSI-RS and so on.

The allocation section 123 allocates the reference signals generated in the reference signal generating section 122. In particular, when one of a plurality of CCs is made subject to non-transmission, the allocation section 123 allocates the ZP-RS to a predetermined resource location of a specific CC. Also, the allocation section 123 allocates the CRS and the ZP-RS in different resource locations. Furthermore, the allocation section 123 carries out the allocation so that the density of placing the CRS that is allocated to a specific CC is higher than the density of placing the CRSs that are allocated to the other CCs.

FIG. 14 is a block diagram to illustrate a structure of a user terminal 20 according to the present embodiment. As illustrated in FIG. 14, the user terminal 20 is configured by including a receiving section 201, a measurement section 202 and a transmission section 203.

The receiving section 201 receives downlink signals (downlink data signals, downlink control signals, downlink reference signals, broadcast signals and so on) from the macro base station 11 and/or the small base stations 12. Also, the receiving section 201 receives higher layer control information from the macro base station 11 and/or the small base station 12. The higher layer control information refers to control information that is sent by RRC (Radio Resource Control) signaling or by MAC signaling.

To be more specific, the receiving section 201 receives a signal (for example, CSI-RS configuration) for reporting the measurement region of each small cell C2 in CC #1, to the user terminals 20, from the macro base station 11. Alternatively, the receiving section 201 receives a signal for reporting the updating rule, which includes cell indices and an indication as to whether to use addition or subtraction, to the user terminals 20, and which is transmitted from the macro base station 11.

The measurement section 202 measures received quality by using the reference signals transmitted from the radio base station. When the above first example is employed, the measurement section 202 measures a plurality of received quality based on reference signals that are allocated to a specific CC among a plurality of CCs, and ZP-RSs that are configured by the radio base station that makes one of the plurality of CCs subject to non-transmission. Also, when the above second example is employed, the measurement section 202 acquires a plurality of total received signal power (RSSIs) from the received quality measured, based on the updating rule that is reported when one of a plurality of CCs is made subject to non-transmission.

The transmission section 203 transmits uplink signals (uplink data signals, uplink control signals and uplink reference signals) to the macro base station 11 and/or the small base stations 12. Also, the transmission section 203 transmits higher layer control information to the macro base station 11 and/or the small base stations 12.

To be more specific, the transmission section 203 reports measurement reports (RSRPs/RSRQs) based on the RSRPs/RSSIs measured in the measurement section 202, to the macro base station 11.

Now, although the present invention has been described in detail with reference to the above embodiment, it should be obvious to a person skilled in the art that the present invention is by no means limited to the embodiment described herein. The present invention can be implemented with various corrections and in various modifications, without departing from the spirit and scope of the present invention defined by the recitations of the claims. For example, a plurality of examples described above may be combined and implemented as appropriate. Consequently, the descriptions herein are provided only for the purpose of explaining examples, and should by no means be construed to limit the present invention in any way.

The disclosure of Japanese Patent Application No. 2013-078688, filed on Apr. 4, 2013, including the specification, drawings and abstract, is incorporated herein by reference in its entirety.

1. A radio base station that communicates with a user terminal by using a plurality of carriers into which a communication band is divided, comprising:
a generating section that generates reference signals for allowing the user terminal to measure received quality; and
an allocation section that controls allocation of the reference signals,
wherein, when one of the plurality of carriers is made subject to non-transmission, the allocation section configures a zero-power RS in a predetermined resource location of a specific carrier.

2. The radio base station according to claim 1, wherein the allocation section allocates a cell-specific reference signal (CRS) for measuring received power and the zero-power RS in different resource locations.

3. The radio base station according to claim 2, wherein the zero-power RS is a zero-power CSI-RS.

4. The radio base station according to claim 1, wherein the allocation section carries out the allocation so that a density of placing a CRS that is allocated to the specific carrier is higher than a density of placing CRSs that are allocated to other carriers.

5. The radio base station according to claim 3, wherein a channel state is measured by using the zero-power CSI-RS.

6. A user terminal that communicates with a radio base station by using a plurality of carriers, comprising:
a measurement section that measures received quality by using reference signals transmitted from the radio base station; and
a transmission section that feeds back information related to the received quality,
wherein the measurement section measures a plurality of received quality based on a cell-specific reference signal (CRS) and a zero-power RS that are allocated to one carrier among a plurality of carriers.

7. The user terminal according to claim 6, wherein the zero-power RS is configured by a radio base station that makes one of the plurality of carriers subject to non-transmission.

8. (canceled)

9. A radio communication method for a user terminal and a radio base station using a plurality of carriers into which a communication band is divided, comprising:
when one of the plurality of carriers is made subject to non-transmission, configuring, in the radio base station, a zero-power RS in a predetermined resource location of a specific carrier;
measuring, in the user terminal, a plurality of received quality based on a reference signal allocated to one carrier among the plurality of carriers, and a zero-power RS configured by the radio base station that makes one of the plurality of carriers subject to non-transmission; and
feeding back, in the user terminal, information related to the received quality.
